(19) United States
(12) Patent Application Publication
(10) Pub. No.: US 2007/0164953 A1
(43) Pub. Date: Jul. 19, 2007

(54) Transflective liquid crystal display and driving method of the same

(75) Inventors: Chun-Ming Huang, Tan Tsu Hsiang (TW); Lin Lin, Tai Chung City (TW); Chih-Chang Lai Lai, Tai Ping City (TW); Yi-Chin Lin, Tai Chung City (TW); Shin-Tai Lo, Miao Li City (TW); Yueh-Nan Chen, Feng Yuan City (TW); Tai-Yuan Chen, Tai Chung City (TW)

Correspondence Address: BIRCH STEWART KOLASCH & BIRCH, PO BOX 747, FALLS CHURCH, VA, 22040-0747, US

(73) Assignee: WINTEK CORPORATION

(21) Appl. No.: 11/588,255

(22) Filed: Oct. 27, 2006

(30) Foreign Application Priority Data
Jan. 17, 2006 (TW) 095101670

(51) Int. Cl. G09G 3/36

(52) U.S. Cl. 345/88

(57) ABSTRACT

A transflective liquid crystal display includes a plurality of pixels. Each pixel includes a plurality of primary color sub-pixels and a brightness-enhancing sub-pixel. The reflective region of the transflective liquid crystal display is formed only on the brightness-enhancing sub-pixel.

### BACKGROUND OF THE INVENTION

(a) Field of the Invention

The invention relates to a transflective liquid crystal display, particularly to a four-color transflective liquid crystal display.

(b) Description of the Related Art

FIG. 1 shows a schematic diagram illustrating a conventional pixel structure 100 of a RGB (red, green and blue) three-color transflective liquid crystal display. As shown in FIG. 1, red, green and blue sub-pixels are formed by providing red, green and blue color filters 106a, 106b and 106c on an upper substrate 102, forming pixel electrodes 108 on a lower substrate 104 that are positioned corresponding to the color filters, and providing a liquid crystal layer 110 interposed between the two substrates 102 and 104. Reflective films 112 are formed to cover part of the pixel electrodes 108 to allow a transflective LCD to have a transmissive region and a reflective region. Hence, when one stays indoors, light from a backlight module (not shown) passes through the transmissive region to display images. In comparison, when one stays outdoors, the ambient light is reflected in the reflective region to provide high panel brightness and pure pixel color. However, compared with the transmission light, the reflection light has to pass through the same color filter twice before arriving the human eye. Hence, the panel brightness of the transflective LCD is severely restricted by the transmittance of color filters and often unsatisfactory under the reflective mode.

FIGS. 2A and 2B show schematic diagrams illustrating another design of the three-color transflective LCD. FIG. 2A shows a schematic diagram illustrating a pixel structure 200 of the transflective LCD, and FIG. 2B shows the sectional structure along line A-A of FIG. 2A. Referring to FIGS. 2A and 2B, in order to enhance the panel brightness of the transflective LCD, additional openings 114 are provided on the color filters 106a, 106b and 106c to increase the amount of the ambient light entering the reflective region. However, though the panel brightness of the transflective LCD is increased under the reflective mode, the color purity of the primary colors (red, green and blue) is changed. That is to say, as shown in FIG. 3, the CIE chromaticity coordinates of the primary colors are changed, and thus the CIE chromaticity triangle for the transflective LCD shown in FIG. 2B shrinks to a smaller triangle when compared with that for the transflective LCD shown in FIG. 1. This results in breaking up the former percentage relationship among the red, green, and blue color components of a displayed image.

### BRIEF SUMMARY OF THE INVENTION

Therefore, an object of the invention is to provide a transflective liquid crystal display and its driving method to have high panel brightness and low power consumption under the reflective mode and to avoid color purity variation existing in the conventional design.

According to the invention, a transflective liquid crystal display includes a plurality of pixels, and each pixel includes multiple primary color sub-pixels and a brightness-enhancing sub-pixel. In each pixel, the reflective region of the transflective liquid crystal display is formed on the brightness-enhancing sub-pixel and non-transmissive region of the multiple primary color sub-pixels. For example, the primary color sub-pixels may include red, green, and blue sub-pixels, or include cyan, magenta, and yellow color sub-pixels. Also, the brightness-enhancing sub-pixel may be a white color sub-pixel.

Through the design of the invention, since the reflective region is formed on the brightness-enhancing sub-pixel and non-transmissive region of the multiple primary color sub-pixels, color images are displayed to maintain the color saturation of primary colors under the transmissive mode; on the other hand, under the reflective mode, black-and-white images are displayed at a considerably high level of panel brightness, thereby achieving an optimum design capable of balancing color saturation and display brightness in consideration of various display environments.

Besides, according to the invention, since the primary color sub-pixels cease to function under the reflective mode, image data having a comparatively low voltage level are sent to the primary color sub-pixels under the reflective mode to lower power consumption.

### BRIEF DESCRIPTION OF THE DRAWINGS

The features and advantages of the invention are illustrated by way of example and are by no means intended to limit the scope of the invention to the particular embodiments shown, and in which:

FIG. 1 shows a schematic diagram illustrating a conventional pixel structure of a three-color transflective liquid crystal display.

FIGS. 2A and 2B show schematic diagrams illustrating another design of the conventional three-color transflective LCD.

FIG. 3 shows a CIE color coordinate diagram illustrating color saturation variation as result of the conventional design.

FIGS. 4A to 4C show schematic diagrams illustrating an embodiment of a four-color transflective liquid crystal display according to the invention.

FIGS. 5A to 5C show schematic diagrams illustrating another embodiment of a four-color transflective liquid crystal display according to the invention.

FIGS. 6A to 6C show schematic diagrams illustrating the design of the invention in comparison with the conventional design.

FIGS. 7A to 7C show schematic diagrams illustrating another embodiment of a four-color transflective liquid crystal display according to the invention.

FIGS. 8A to 8C show schematic diagrams illustrating another embodiment of a four-color transflective liquid crystal display according to the invention.

FIG. 9 shows ideal relationship between the applied voltage and the light transmittance of liquid crystal.

FIG. 10 shows a flow chart illustrating a driving method of a transflective liquid crystal display according to the invention.

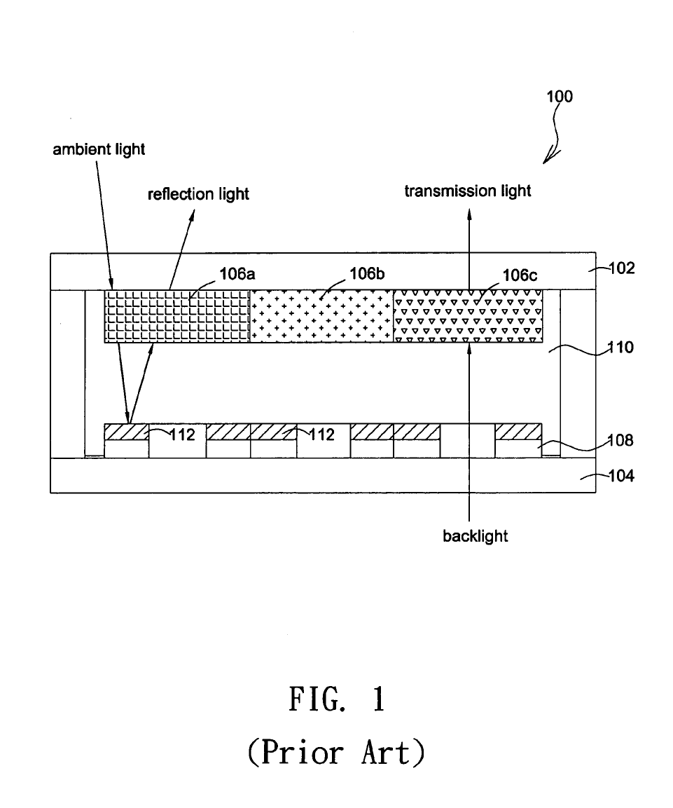

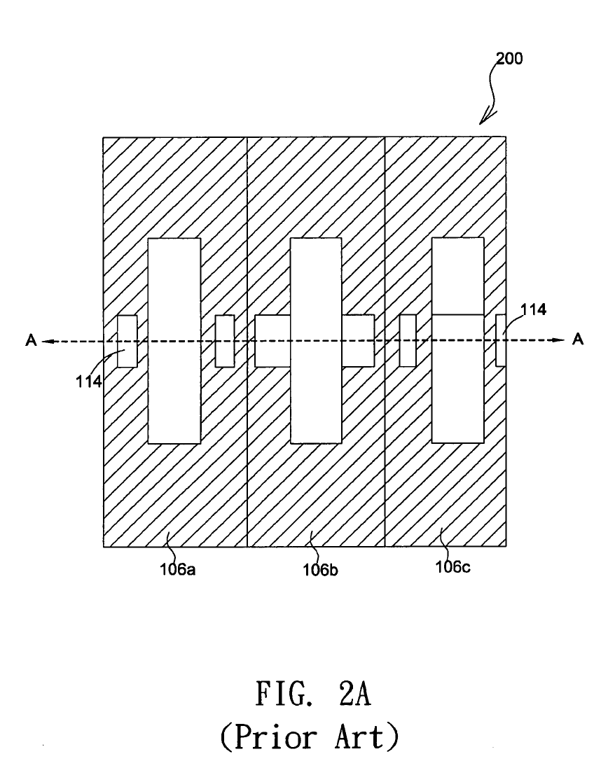

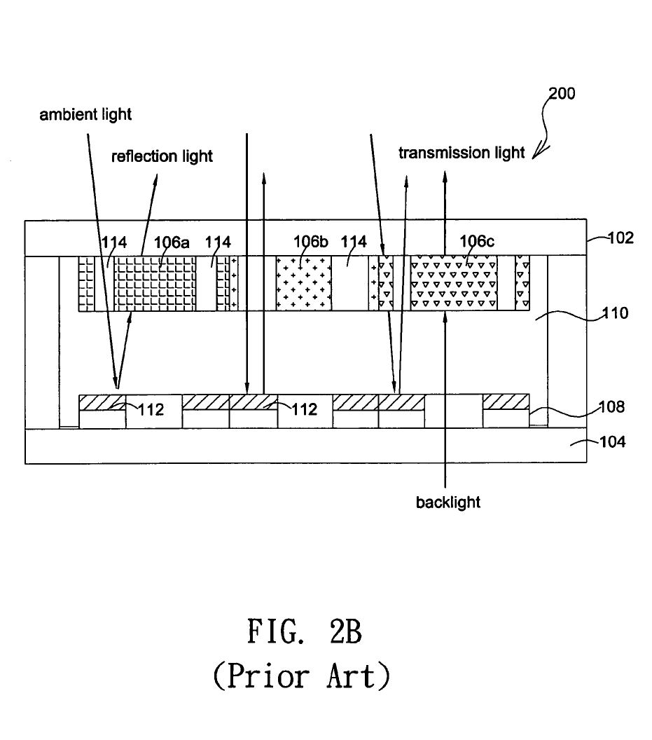

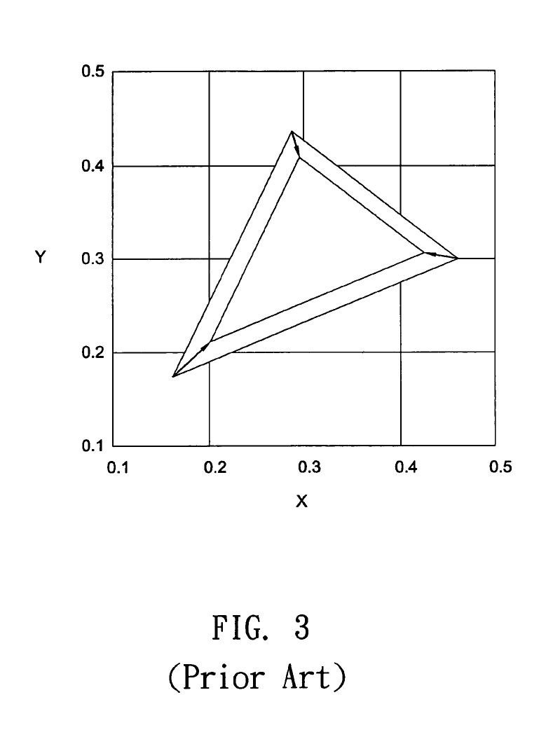

### DETAILED DESCRIPTION OF THE INVENTION

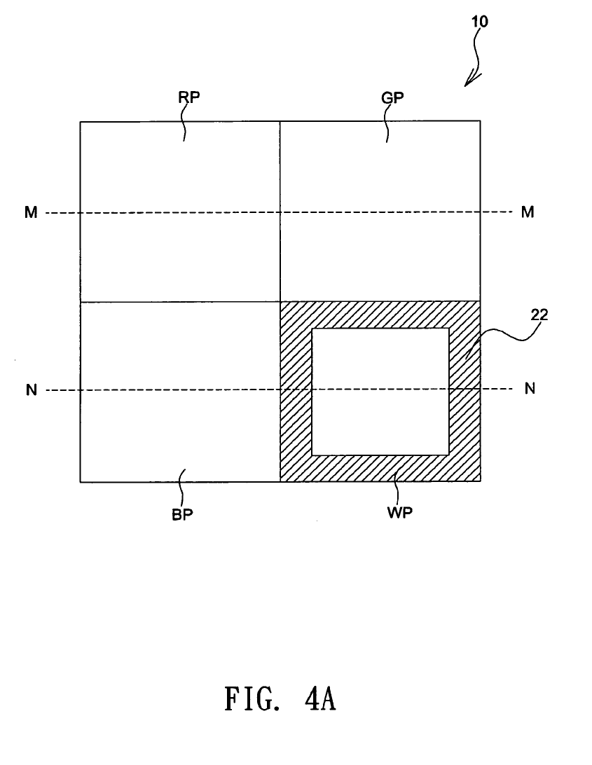

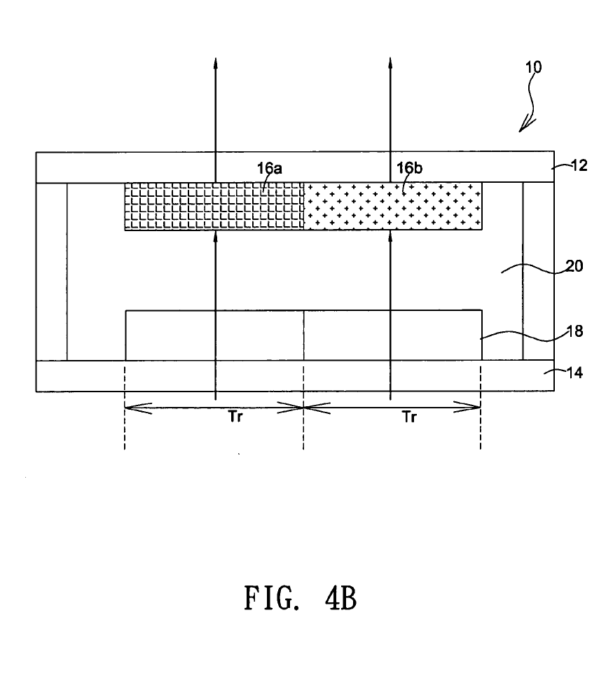

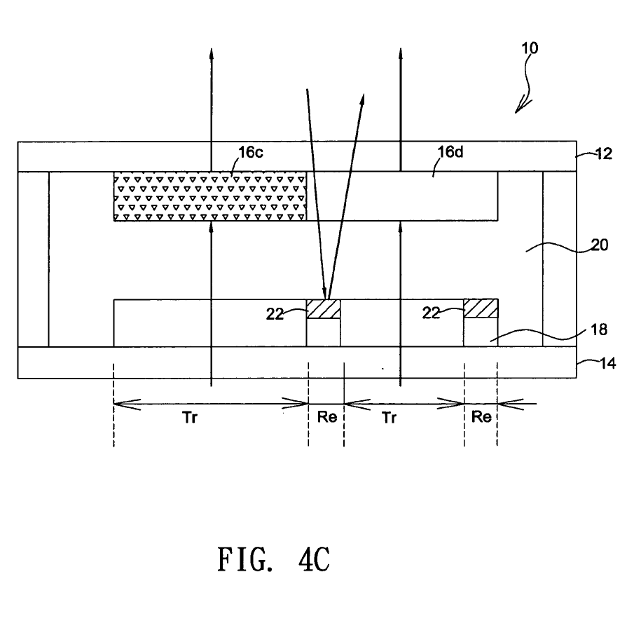

FIGS. 4A to 4C show schematic diagrams illustrating an embodiment of a four-color transflective liquid crystal display (transflective LCD) according to the invention. FIG. 4A shows a schematic diagram of a pixel 10, FIG. 4B shows a sectional structure diagram along line M-M of FIG. 4A, and FIG. 4C shows a sectional structure diagram along line N-N of FIG. 4A.

As shown in FIG. 4A, the pixel 10 of a transflective LCD includes red (R), green (G), and blue (B) primary color sub-pixels RP, GP, and BP, and a white (W) color brightness-enhancing sub-pixel WP. In this embodiment, the reflective region of the transflective LCD (hatched portion denoted by reference numeral 22 and shown in FIG. 4A) is formed only on the white color sub-pixel WP. As used in this description and the appended claims, the term “sub-pixel” indicates a basic functional element for displaying images in a color liquid crystal display, whose structure will be described later with reference to FIGS. 4B and 4C.

The arrangement of the reflective region can be seen clearly from the sectional structure diagrams shown in FIGS. 4B and 4C. Referring to FIG. 4B, a red color filter 16a and a green color filter 16b are formed on a portion of an upper substrate 12, and a pixel electrode 18 is formed on a lower substrate 14, with a liquid crystal layer 20 interposed between the two substrates 12 and 14. According to this embodiment, part of the pixel electrode 18 that corresponds to the positions of the red color filter 16a and the green color filter 16b (i.e. the approximate region on which the color filters are projected) are made of transparent materials, such as indium tin oxide (ITO) or indium zinc oxide (IZO) transparent conductive films. Thus the red and green color sub-pixels form transmissive regions Tr of a transflective LCD. Further, as shown in FIG. 4C, a blue color filter 16c is formed on a portion of the upper substrate 12, and part of the pixel electrode 18 that corresponds to the position of the blue color filter 16c is also formed from transparent conductive films. Thus the blue color sub-pixel also forms a transmissive region Tr of a transflective LCD. In comparison, a portion of the upper substrate 12 on which no color filters are formed (i.e. transparent light-transmitting region 16d) constitutes a white color sub-pixel WP functioning as a brightness-enhancing sub-pixel for a four-color transflective LCD. In this embodiment, a reflective film 22 with hollow square shape is positioned on the lower substrate 14 corresponding to the transparent light-transmitting region 16d (i.e. the approximate region on which the transparent light-transmitting region 16d is projected). Thus only the white color sub-pixel WP includes both the reflective region Re and the transmissive region Tr of a four-color transflective LCD.

According to this embodiment, the reflective film 22 is only provided in the white sub-pixel WP but not in the red, green, and blue primary color sub-pixels RP, GP, and BP. As a result, color images are displayed to maintain the color saturation of primary colors under the transmissive mode since the primary color sub-pixels RP, GP, and BP only have transmissive regions Tr. Further, the transmissive region Tr of the white color sub-pixel also provides brightness-enhancing effect without influencing the color saturation under the transmissive mode, because the brightness gray level of the white color sub-pixel is obtained by an operation for extracting white component from input RGB color data, which can maintain the color saturation of the original RGB primary colors. On the other hand, under the reflective mode, black-and-white images are displayed at a considerably high level of panel brightness since ambient light are reflected in the reflective region of the white color sub-pixel WP.

Referring back to FIG. 4C, though a double-layer reflective electrode is constructed in the reflective region Re by the pixel electrode 18 and the reflective film 22 overlying the pixel electrode 18, the manner of forming a reflective electrode is not limited to the above example. For instance, a single-layer reflective electrode formed from a conductive reflective film may be used instead.

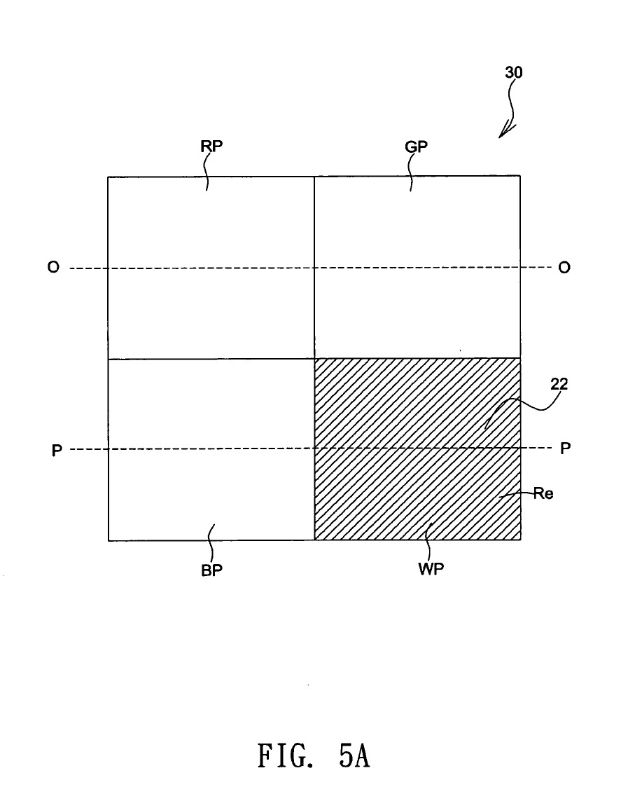

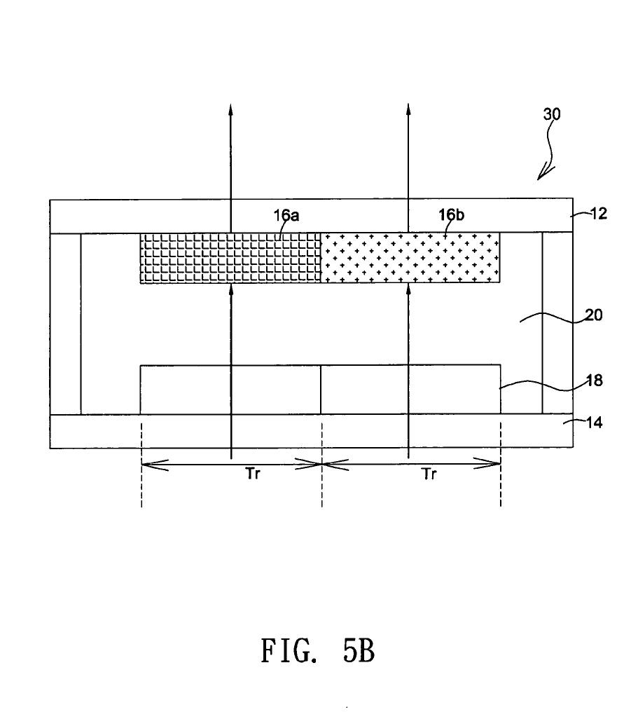

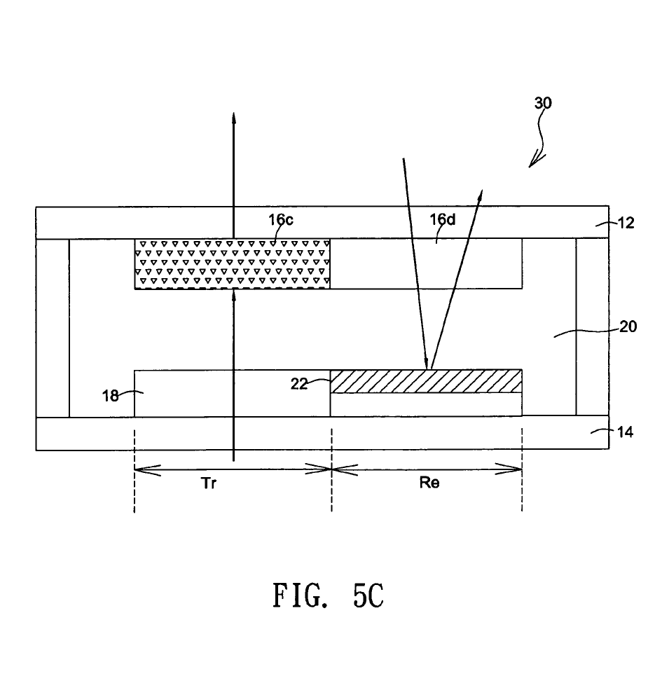

FIGS. 5A to 5C show schematic diagrams illustrating another embodiment of the invention, where FIG. 5B shows a sectional structure diagram along line O-O of FIG. 5A, and FIG. 5C shows a sectional structure diagram along line P-P of FIG. 5A. According to this embodiment, the reflective film 22 covers the whole pixel area of the white color sub-pixel WP. In other words, the white color sub-pixel WP includes only the reflective region Re and does not include any transmissive region Tr. In that case, though the white color sub-pixel WP fails to provide the brightness-enhancing effect under the transmissive mode, the ambient light utilization efficiency under the reflective mode is further improved because of the increase in the areas of the reflective region Re. Moreover, referring to FIG. 5C, though a double-layer reflective electrode is constructed in the reflective region Re by the pixel electrode 18 and the reflective film 22 overlying the pixel electrode 18, the manner of forming a reflective electrode is not limited to the example shown in FIG. 5C. For instance, a single-layer reflective electrode formed from a conductive reflective film may be used instead.

It is seen from the above the area and the position of the reflective region Re formed on the white color sub-pixel WP are not limited and can be arbitrary selected according to any factor such as environment brightness. For instance, if higher panel brightness is requested under the transmissive mode, the reflective region Re may be formed as hollow square-shaped to produce a middle transmissive region Tr so as to increase the light-transmission areas of the white color sub-pixel WP, as shown in FIG. 4A. Also, in that case, the reflective film 22 with a hollow square shape is naturally formed at a position overlapping with the black matrix layer to thus increase the aperture ratio of a display device. On the other hand, if higher display brightness is requested under the reflective mode, the areas of the reflective region Re may be gradually increased to meet the requirement and finally may cover the whole white color sub-pixel, as shown in FIG. 5A where the reflective film 22 covers the whole white color sub-pixel WP.

Further, the manner of forming the reflective region Re is not restricted. For instance, it may be formed by coating a metallic reflective film such as aluminum film on a pixel electrode. Alternatively, an electrode with high reflectivity, such as an aluminum or a silver electrode, may be directly provided on the white color sub-pixel WP to form the reflective region Re.

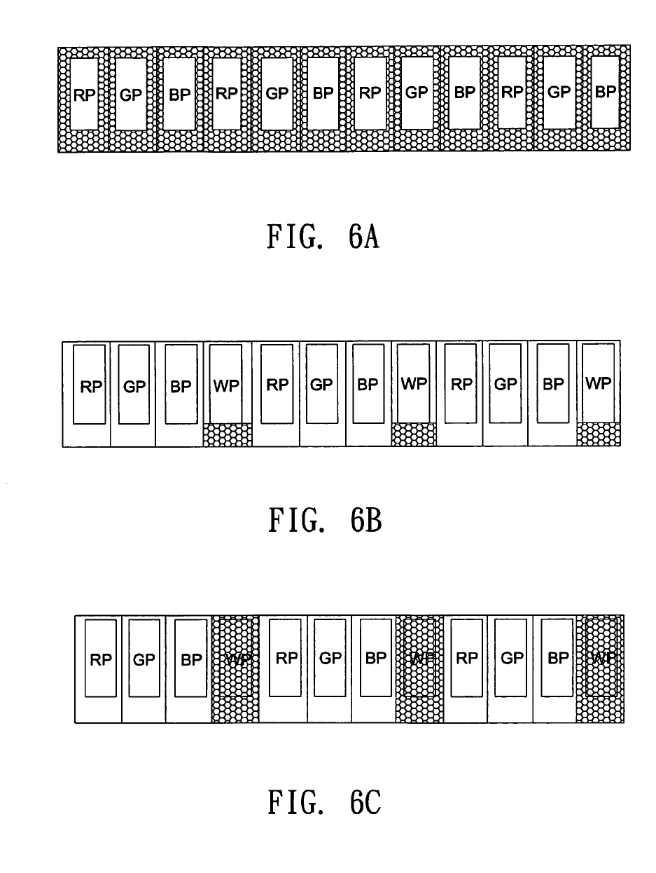

FIGS. 6A to 6C show schematic diagrams illustrating the design of the invention in comparison with the conventional design. FIG. 6A shows the design of a conventional RGB three-color transflective LCD, FIG. 6B shows a first embodiment of the invention where the white color sub-pixel includes both reflective and transmissive regions, and FIG. 6C shows a second embodiment of the invention where the white color sub-pixel includes only reflective regions. In these figures, the rounded-dot accumulation portion represents the spread of the reflective film 22.

In this comparison example, the area of each sub-pixel (R, G, B, or W) is 9747 μm² (57 μm*171 μm). As shown in FIG. 6A, the total areas of twelve sub-pixels are 116964 μm² in which the transmissive region possesses half of the area, 58482 μm², and the reflective region possesses half of the area, 58482 μm². Assume luminosity factor equals 1 under the present condition, the luminance efficiency value of the transmissive region is 58482 (=58482*1), and the luminance efficiency value of the reflective region is 58482 (=58482*1). Thus, the light utilization ratio is (58482+58482)/116964=100% for the three-color transflective pixel. On the other hand, as shown in FIG. 6B, the total areas of twelve sub-pixels is also 116964 μm² in which the area of the transmissive region of the RGB sub-pixels is (¾)*(¾)*116964=65792 μm², the area of the transmissive region of the white color sub-pixel is (¼)*(¾)*116964=21930 μm², and the area of the reflective region of the white color sub-pixel is (¼)*(¼)*116964=7310 μm². Next, the luminosity factor for the white color sub-pixel WP equals 3 (calculation is based on the condition that light passing through the white color sub-pixel are not blocked by a red, a green, and a blue color filters, and that light from a white color sub-pixel covers the wavelengths of red, green, and blue colors), and thus the luminosity factor for the reflective region of the white color sub-pixel is 3*(1/0.8)=3.75 (calculation is based on the condition that light from a white color sub-pixel covers the wavelengths of red, green, and blue colors, and that the transmittance of a red, a green, or a blue color filter is set as 0.8). Therefore, the luminance efficiency value of the transmissive region is 131582 (=65792*1+21930*3), and the luminance efficiency value of the reflective region is 27412 (=7310*3.75). Thus, the light utilization ratio is (131583+27412)/116964=136% for the first embodiment of the invention.

Finally, as shown in FIG. 6C, the total areas of twelve sub-pixels are also 116964 μm² in which the area of the transmissive region of the RGB sub-pixels is (¾)*(¾)*116964=65792 μm², and the area of the reflective region of the white color sub-pixel is (¼)*116964=29241 μm² (the white color sub-pixel includes only the reflective region). The luminosity factor for the white color sub-pixel also equals 3.75. Thus, the luminance efficiency value of the transmissive region is 65792 (65792*1) and the luminance efficiency value of the reflective region is 109653.75 (=29241*3.75). Therefore, the light utilization ratio is (65792+109653.75)/116964=150% for the second embodiment of the invention.

From the above calculation results, it cab be clearly seen the utilization ratio of the ambient light increases according to the deign of the invention. Under the reflective mode, for the case of having intense ambient light, good display quality is difficult to be obtained even for a color display when the panel brightness is insufficient. In other words, the panel brightness is a determining factor as to good display quality under the reflective mode. As a result, according to the invention, under the transmissive mode color images are displayed to maintain the color saturation of primary colors, while under the reflective mode black-and-white images are displayed at a considerably high level of panel brightness, thereby achieving an optimum design capable of balancing color saturation and display brightness in consideration of various display environments.

Furthermore, the pixel structure according to the invention is not restricted to use red, green, and blue primary color sub-pixels as long as another primary color sub-pixels can provide various mixing colors. For example, in the case of utilizing subtractive color mixture, cyan (C), magenta (M), and yellow (Y) primary color sub-pixels including cyan (C), magenta (M), and yellow (Y) color filters may also be used. Besides, the arrangement of the four-color sub-pixels is not limited to a specific example. For instance, the four-color sub-pixels may be arranged to form a checkerboard type layout shown in FIG. 4A, or a stripe type layout shown in FIG. 6B. Also, the invention may integrate a Pentile matrix sub-pixel arrangement that employs sub-pixel rendering algorithms to further enhance panel brightness and display quality. In the Pentile matrix sub-pixel arrangement, the location of each red color sub-pixel and green color sub-pixel are alternated on each parallel and perpendicular row to form a basis on which the sub-pixel rendering algorithms performed.

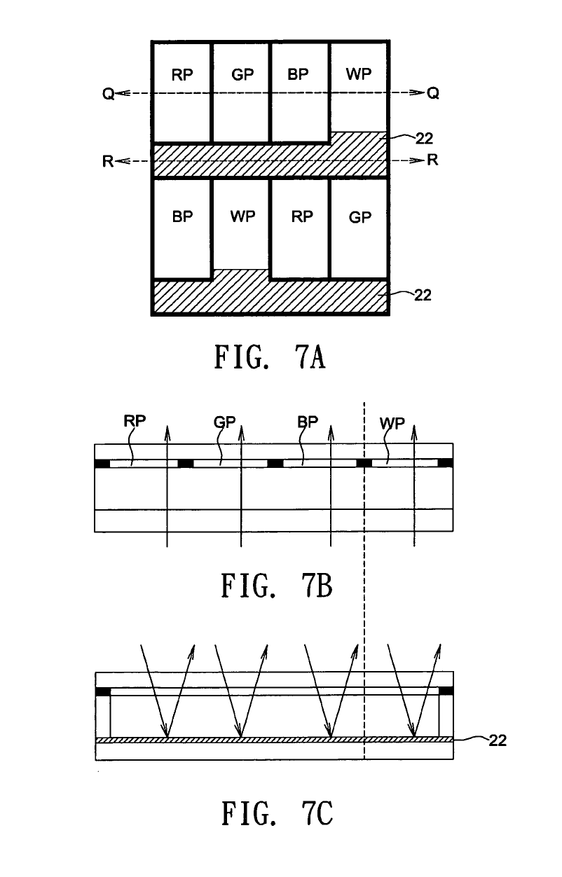

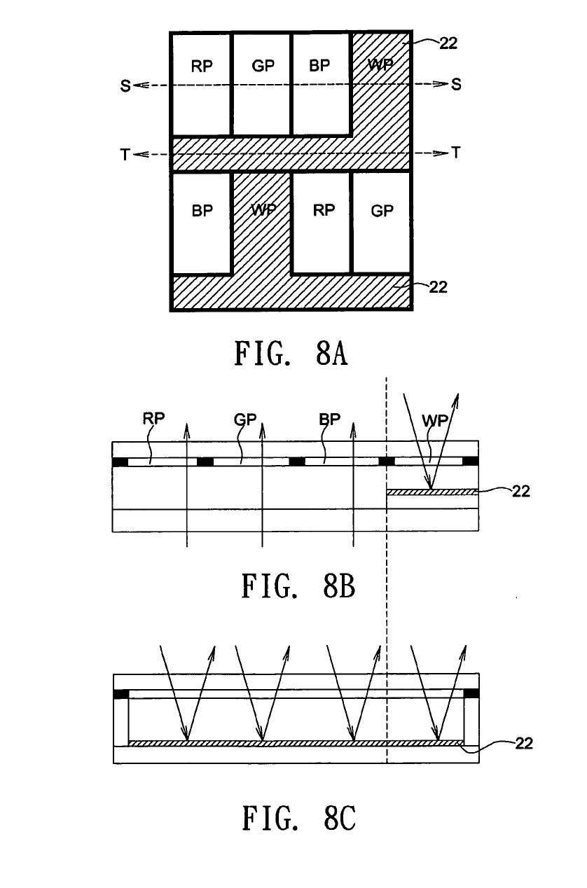

FIGS. 7A to 8C illustrate another embodiments of the invention in comparison with the conventional design, where the Pentile matrix sub-pixel arrangement is incorporated into these embodiments. As shown in FIG. 7A, since each two white color sub-pixels are interlaced and positioned at different columns in a Pentile matrix, the reflective film 22 (hatched region) formerly spread only on the white color sub-pixel may extend to the exterior array region of the red, green, and blue sub-pixels so as to increase the total areas of the reflective region. FIG. 7B shows the sectional structure diagram along line Q-Q of FIG. 7A, and FIG. 7C shows the sectional structure diagram along line R-R. As shown in FIG. 7A, the white color sub-pixel includes both reflective and transmissive regions. If the area of each sub-pixel (R, G, B, or W) is set as 9747 μm² (57 μm*171 μm), the total areas of twelve sub-pixels are 116964 μm² in which the area of the transmissive region of the red, green and blue sub-pixels is (¾)*(¾)*116964=65792 μm², the area of the transmissive region of the white color sub-pixel is (¼)*(¾)*116964=21930 μm², and the area of the reflective region of the white color sub-pixel is (¼)*116964=29241 μm². Thus, the luminance efficiency value of the transmissive region equals 131582 (=65792*1+21930*3), and the luminance efficiency value of the reflective region equals 109653 (=29241*3.75). Therefore, the light utilization ratio is (131583+109653)/116964=206% for this embodiment of the invention.

FIG. 8A shows a sub-pixel arrangement similar to that in FIG. 7A, but the white color sub-pixel includes only the reflective region. FIG. 8B shows the sectional structure diagram along line S-S of FIG. 8A, and FIG. 8C shows the sectional structure diagram along line T-T of FIG. 8A. As shown in FIG. 8A, the reflective film 22 is spread on the whole pixel area of the white color sub-pixel and extended to the exterior array region of the red, green, and blue sub-pixels. If the area of each sub-pixel (R, G, B, or W) is set as 9747 μm², the total areas of twelve sub-pixels are 116964 μm² in which the area of the transmissive region of the red, green and blue sub-pixels is (¾)*(¾)*116964=65792 μm², and the area of the reflective region of the white color sub-pixel is [(¼)+(¾)*(¼)]*116964=51171 μm². Thus, the luminance efficiency value of the transmissive region equals 65792 (=65792*1) and the luminance efficiency value of the reflective region equals 191891 (=51171*3.75). Therefore, the light utilization ratio equals (65792+191891)/116964=220% for this embodiment of the invention.

From the above examples, except the reflective film 22 is spread on the white color sub-pixel, it may also be provided in the exterior array region of the red, green and blue sub-pixels so as to further increase the light utilization ratio. In other words, in the process of forming the reflective film 22, the color purity is maintained according to the invention only as the reflective film 22 is prevented from being formed on a region overlapping with the positions of the color filters (i.e. approximate region on which the color filters are projected). More specifically, except the above condition should be met, the reflective film 22 may be spread on any other regions on the lower substrate 14. For example, the reflective film 22 may be spread on partial or whole pixel areas of a white color sub-pixel, or alternatively, extended to the exterior array region of the red, green, and blue sub-pixels to further increase the light utilization ratio.

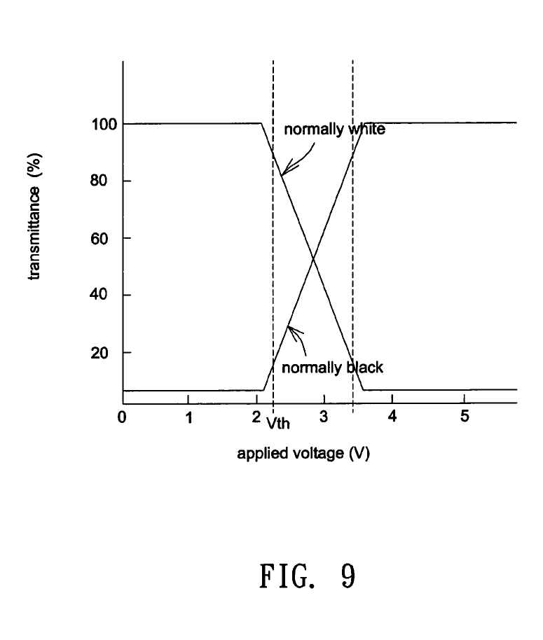

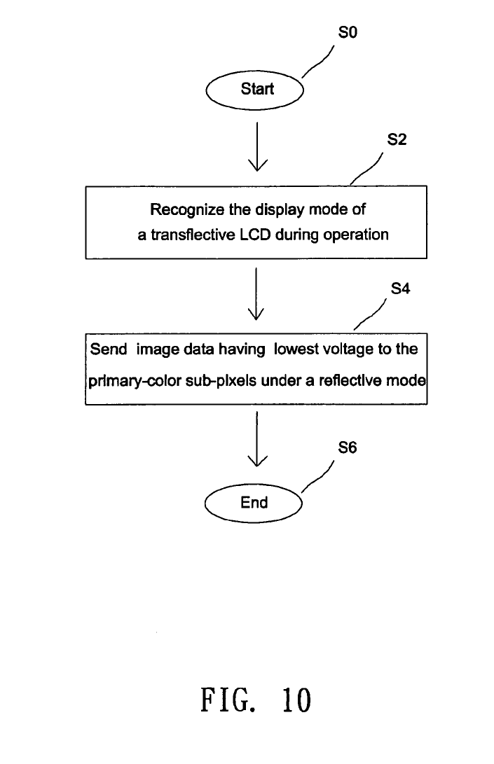

Besides, according to the implementation of the invention, since the reflective region of a transflective LCD is formed only on the white color sub-pixel, the red, green and blue sub-pixels may cease to function under the reflective mode. Under the circumstance, image data having a comparatively low voltage level are sent to the red, green and blue sub-pixels under the reflective mode to lower power consumption. The image data sent under the reflective mode may be scanning signals corresponding to RGB sub-pixels to keep the voltage value smaller than the liquid crystal threshold voltage Vth indicated in FIG. 9. Note that the liquid crystal threshold voltage Vth indicated in FIG. 9 is determined with respect to a transmittance value of 10%.

Therefore, as shown in FIG. 10, a method for driving a transflective LCD having low power consumption is provided as the following steps:

S0: Start.

S2: Recognize whether the display mode of the transflective liquid crystal display during operation is a reflective mode that uses ambient light or a transmissive mode that uses a backlight.

S4: Sent image data having a voltage smaller than the liquid crystal threshold voltage into the primary color sub-pixels (red, green, and blue sub-pixels) when the display mode during operation is the reflective mode.

S6: End.

While the invention has been described by way of examples and in terms of the preferred embodiments, it is to be understood that the invention is not limited to the disclosed embodiments. On the contrary, it is intended to cover various modifications and similar arrangements as would be apparent to those skilled in the art. Therefore, the scope of the appended claims should be accorded the broadest interpretation so as to encompass all such modifications and similar arrangements.

What is claimed is:

1. A transflective liquid crystal display, comprising:
a plurality of pixels, each of the pixels comprising multiple primary color sub-pixels and a brightness-enhancing sub-pixel, wherein the reflective region of the transflective liquid crystal display is formed only on the brightness-enhancing sub-pixel.

2. The transflective liquid crystal display as claimed in claim 1, wherein the area of the reflective region is smaller than the whole area of the brightness-enhancing sub-pixels.

3. The transflective liquid crystal display as claimed in claim 2, wherein each brightness-enhancing sub-pixel includes both the reflective region and a transmissive region, and the transmissive region is surrounded by the reflective region.

4. The transflective liquid crystal display as claimed in claim 1, wherein the primary color sub-pixels include red, green, and blue sub-pixels, and the brightness-enhancing sub-pixel is a white color sub-pixel.

5. The transflective liquid crystal display as claimed in claim 1, wherein the primary color sub-pixels include cyan, magenta, and yellow sub-pixels, and the brightness-enhancing sub-pixel is a white color sub-pixel.

6. The transflective liquid crystal display as claimed in claim 1, wherein the primary color sub-pixels and the brightness-enhancing sub-pixel are arranged to form a checkerboard type or a stripe type layout.

7. The transflective liquid crystal display as claimed in claim 1, wherein the primary color sub-pixels and the brightness-enhancing sub-pixel are arranged to form a Pentile matrix.

8. The transflective liquid crystal display as claimed in claim 1, wherein the primary color sub-pixels comprise:
a plurality of color filters formed on a first substrate of the transflective liquid crystal display; and
a transparent electrode formed on a second substrate of the transflective liquid crystal display and positioned corresponding to the color filters;
and the brightness-enhancing sub-pixel comprises:
a transparent light-transmitting region formed on the first substrate; and
a reflective electrode formed on the second substrate and positioned corresponding to the transparent light-transmitting region.

9. The transflective liquid crystal display as claimed in claim 8, wherein the reflective electrode is a single-layer electrode made of metallic reflective films, or the reflective electrode is a double-layer electrode made of a transparent conductive film and a reflective film that covers the transparent conductive film.

10. The transflective liquid crystal display as claimed in claim 8, wherein the transparent electrode is formed on the second substrate at the position on which the color filters are projected, and the reflective electrode is formed on the second substrate at the position on which the transparent light-transmitting region are projected.

11. A transflective liquid crystal display, comprising:
a first substrate on which light-filtering regions and transparent light-transmitting regions are formed, the light-filtering regions being spread with color filters having different colors, and the transparent light-transmitting regions containing no color filters;
a second substrate opposite to the first substrate and divided into a first region overlapping with the light-filtering regions, a second region overlapping with the transparent light-transmitting regions, and a third region that is the remaining region of the second substrate except for the first and the second regions; and
a liquid crystal layer interposed between the first and the second substrates;
wherein the reflective region of the transflective liquid crystal display includes at least a portion of the second region and excludes the first region.

12. The transflective liquid crystal display as claimed in claim 11, wherein the reflective region includes the entire second region.

13. The transflective liquid crystal display as claimed in claim 11, wherein the reflective region includes at least a portion of the third region.

14. The transflective liquid crystal display as claimed in claim 11, wherein the reflective region is formed from metallic reflective films.

15. The transflective liquid crystal display as claimed in claim 14, wherein the reflective films are formed as a hollow square shape.

16. The transflective liquid crystal display as claimed in claim 11, wherein the color filters include red, green, and blue color filters.

17. The transflective liquid crystal display as claimed in claim 11, wherein the color filters include cyan, magenta, and yellow color filters.

18. The transflective liquid crystal display as claimed in claim 11, wherein the light-filtering regions and the transparent light-transmitting regions are arranged to form a checkerboard type or a stripe type layout.

19. The transflective liquid crystal display as claimed in claim 11, wherein the light-filtering regions and the transparent light-transmitting regions are arranged to form a Pentile Martrix.

20. A driving method of a transflective liquid crystal display, the transflective liquid crystal display comprising a plurality of primary color sub-pixels and brightness-enhancing sub-pixels, wherein the reflective region of the transflective liquid crystal display is formed only on the brightness-enhancing sub-pixels, the driving method comprising the steps of:
recognizing whether the display mode of the transflective liquid crystal display during operation is a reflective mode or a transmissive mode; and
sending image data having a voltage smaller than the liquid crystal threshold voltage into the primary color sub-pixels when the display mode during operation is the reflective mode.

21. The driving method as claimed in claim 20, wherein the primary color sub-pixels include red, green, and blue sub-pixels and the brightness-enhancing sub-pixel is a white color sub-pixel.

22. The driving method as claimed in claim 20, wherein the primary color sub-pixels include cyan, magenta, and yellow sub-pixels, and the brightness-enhancing sub-pixel is a white color sub-pixel.
